(19) United States
(12) Patent Application Publication
(10) Pub. No.: US 2018/0270596 A1
(43) Pub. Date: Sep. 20, 2018

(54) LOUDSPEAKER-DIAPHRAGM AND LOUDSPEAKER INCLUDING THE SAME

(71) Applicant: Panasonic Intellectual Property Management Co., Ltd., Osaka (JP)

(72) Inventor: HIDETOSHI HIRAOKA, Kyoto (JP)

(21) Appl. No.: 15/885,821

(22) Filed: Feb. 1, 2018

(30) Foreign Application Priority Data
Mar. 16, 2017 (JP) 2017-050679

(51) Int. Cl. H04R 31/00; H04R 7/14; H04R 7/12

(52) U.S. Cl. CPC H04R 31/003; H04R 7/14; H04R 7/125; H04R 9/043; H04R 2307/025; H04R 2231/003; H04R 2307/029

(57) ABSTRACT

A loudspeaker diaphragm contains a thermosetting resin as a principal component, and the thermosetting resin includes clicyclopentacliene serving as a framework structure.

### BACKGROUND

### 1. Technical Field

The present disclosure relates to a loudspeaker diaphragm used in a variety of audio apparatuses, and to loudspeakers including the diaphragms.

### 2. Description of the Related Art

Among loudspeaker diaphragms are a cellulose diaphragm that is formed with cellulose via a paper-making process, and a resin diaphragm that is formed with a resin material by molding.

Japanese Patent Unexamined Publication No. 2015-82744, for example, discloses a resin diaphragm that is formed with a thermoplastic resin material such as polypropylene (hereinafter, referred to PP). Japanese Patent Unexamined Publication No. 2011-176621 discloses a diaphragm that includes: a resin layer formed of a resin composition, and a reinforcing layer formed of a fibrous member. The resin composition in the resin layer includes a cyclo-olefin copolymer (abbreviated to COC, hereinafter) as a first resin material, and PP as a second resin material. The resin layer is thermoplastic.

### SUMMARY

The present disclosure is intended to provide a loudspeaker diaphragm that features good thermal characteristics and physical characteristics, reduced weight thereof relative to conventional ones, excellent acoustic characteristics, and a high suitability for mass production as well.

The loudspeaker diaphragm according to an aspect of the present disclosure contains a thermosetting resin as a principal component, and the thermosetting resin includes dicyclopentadiene serving as a framework structure.

When the loudspeaker diaphragm is manufactured with a dicyclopentadiene resin which is a thermosetting resin, the manufacturing process may adopt reaction injection molding that includes mixing two liquids before injection. This allows the manufacturing of the diaphragm that features a smaller thickness and a less weight than diaphragms manufactured with PP.

Moreover, a dicyclopentadiene resin is larger in elastic modulus than PP, and comparable in internal loss to PP. For this reason, the diaphragm according to the present disclosure can achieve excellent acoustic characteristics, in comparison with diaphragms manufactured with PP. Furthermore, dicyclopentadiene shows a rapid rate of cure reaction, resulting in a high suitability for mass production.

In addition, the dicyclopentadiene resin offers a good heat-resisting property, which can achieve good and stable acoustic characteristics and a high sound quality even in severe environments.

### BRIEF DESCRIPTION OF THE DRAWINGS

FIG. 1 is a cross-sectional view of a loudspeaker according to an embodiment of the present disclosure;

FIG. 2 is a cross-sectional view of a diaphragm of the loudspeaker shown in FIG. 1;

FIG. 3 is a view illustrating a configuration of a molding machine for forming the diaphragm shown in FIG. 2;

FIG. 4 is a graph of a relationship between specific moduli and internal losses of loudspeaker diaphragms;

FIG. 5 is a perspective view of a diaphragm in which ribs are integrally formed on a rear surface of the diaphragm, according to an embodiment of the present disclosure; and

FIG. 6 is a cross-sectional view of a diaphragm having a front surface on which a coating film is formed, according to an embodiment of the present disclosure.

### DETAILED DESCRIPTION OF PREFERRED EMBODIMENTS

Prior to describing exemplary embodiments of the present disclosure, problems in conventional technologies will now briefly be described.

A loudspeaker diaphragm which is formed with a resin of PP as a base resin-material, is manufactured by injection molding of a melt that is prepared by melting a solid. Such injection molding causes a limit on reducing the thickness of the diaphragm for making weight savings that are aimed at improving the performance of the loudspeaker. In particular, loudspeakers installed in such as the engine rooms and cabins of vehicles will be subjected to severe environments including high temperatures, high humidity, and thermal shocks. Such loudspeakers require diaphragms that feature less deformation over time, less change in acoustic characteristics, and a high suitability for mass production.

A loudspeaker diaphragm as disclosed in Japanese Patent Unexamined Publication No. 2011-176621, includes a resin layer made of a mixture of PP and COC, and a reinforcing layer provided with the resin layer and configured with a fibrous member. Such a loudspeaker diaphragm is superior in physical properties to loudspeaker diaphragms that are formed with a PP material alone. However, for the loudspeaker diaphragm, there are a limit on weight savings and a low suitability for mass production.

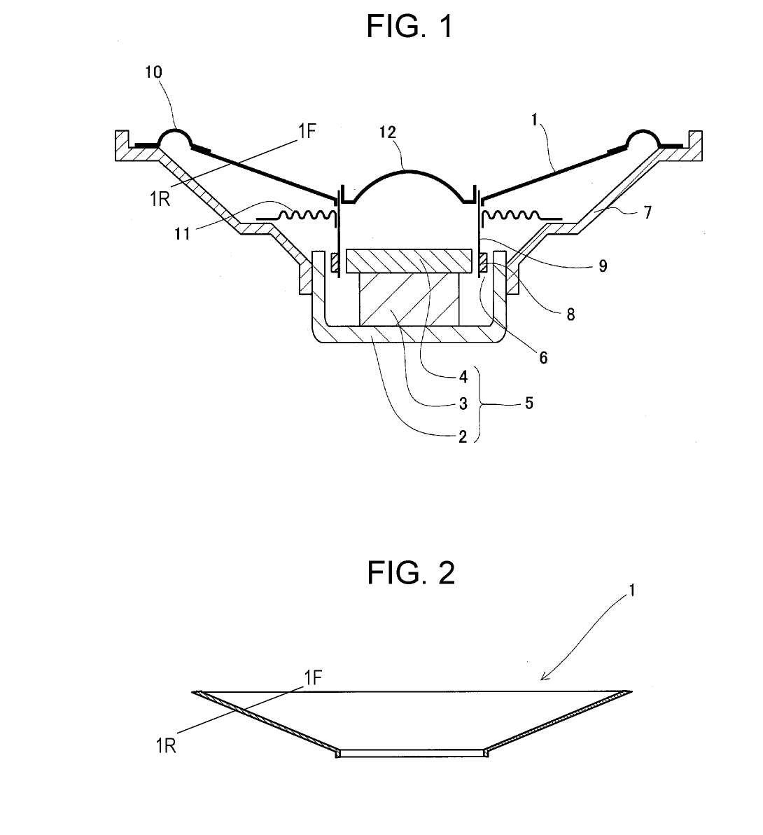

Hereinafter, a loudspeaker and diaphragm 1 according to an embodiment of the present disclosure will be described with reference to the accompanying drawings. FIG. 1 is a cross-sectional view of the loudspeaker according to the embodiment of the present disclosure.

The loudspeaker includes edge 10, diaphragm 1 having a conical shape, magnetic circuit 5, frame 7, voice coil 9, and damper 11. Edge 10 is bonded to the outer periphery of diaphragm 1. Magnetic circuit 5 includes yoke 2, magnet 3, and plate 4. Between the inner periphery of yoke 2 and the outer periphery of plate 4, magnetic gap 6 is formed as a uniform clearance. Frame 7 is attached to yoke 2, which configures magnetic circuit 5, in the vicinity of magnetic gap 6 to support the outer periphery of diaphragm 1 via edge 10. More specifically, the lower end of frame 7 is joined to the outer periphery of yoke 2 while the upper end of frame 7 is joined to the outer periphery of diaphragm 1 via edge 10. Voice coil 9 includes a first end which is attached to the rear surface of diaphragm 1, and a second end on which coil 8 is wound. The wound coil is located in magnetic gap 6. The first end of voice coil 9 is joined to the center portion of diaphragm 1. Damper 11 is joined to both voice coil 9 and frame 7. Around the center of diaphragm 1, dust cap 12 may be disposed to prevent dust from coming into magnetic gap 6.

FIG. 2 is a cross-sectional view of diaphragm 1. For example, the outer periphery of diaphragm 1 has a perfect circle shape. For example, diaphragm 1 has a conical shape which gradually changes concentrically along toward the center.

Diaphragm 1 contains a thermosetting resin, as a principal component, which includes dicyclopentadiene as a framework structure. The term “principal component” as used herein means that the component occupies more than half of the material concerned, i.e. not less than 51 weight percent.

Cyclopentadiene has a cyclic structure composed of five carbon atoms; the cyclic structure has carbon-carbon bonds, two of which are double bonds. Dicyclopentadiene has a structure in which two molecules of such cyclopentadiene are combined in such a manner that each of the molecules causes one of its two double bonds to form bonding with the other molecule. The thermosetting resin, which includes dicyclopentadiene as a framework structure, is formed in such a manner that the two remaining double bonds in the molecule of dicyclopentadiene are caused to form bonding with other molecules; therefore, the resin includes dicyclopentadiene as the framework structure. Note that, the thermosetting resin may have such a structure in which molecules of dicyclopentadiene bond with each other or, alternatively, a molecule of dicyclopentadiene bonds with other chemical species such as phenol. In the following description, such a thermosetting resin is referred to as “DCPD resin.”

The DCPD resin, like PP, is an olefin resin. Compared with PP, the DCPD resin exhibits smaller specific gravity, higher flowability, better moldability, and more excellent mold-releasing properties. Moreover, it features rapid cure reaction and short molding time, resulting in a high suitability for mass production.

Although the specific gravity of the DCPD resin is comparable to that of PP, it exhibits an elastic modulus of 2.0 GPa that is two times larger than the elastic modulus of PP of 1.0 GPa, for example. On the other hand, the internal loss of the DCPD resin is comparable to the internal loss of PP of 0.020, for example.

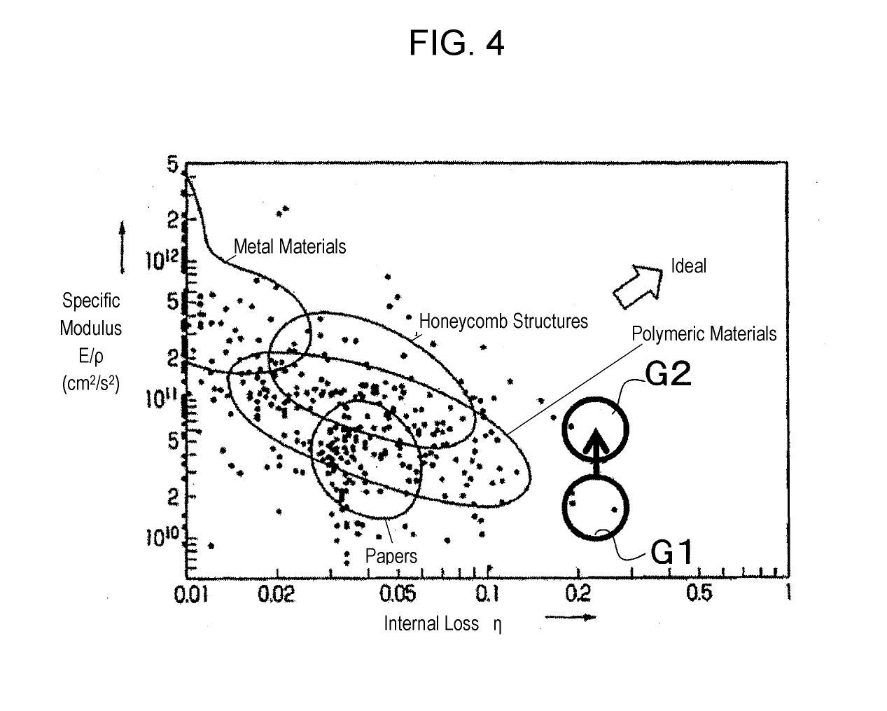

For a loudspeaker diaphragm, a physical balance between elastic modulus and internal loss is preferably such that the internal loss appropriately increases with increasing elastic modulus. FIG. 4 is a graph of a relationship between specific moduli and internal losses of materials for diaphragms. The graph is obtained such that data of both case G1 where PP is used and case G2 where a DCPD resin is used are added to the generally-referred graph that is shown in the literature, i.e. Saeki Tamon, editorial supervisor, “Shin-Ban Supi-ka & Enkuro-ja Hyakka (which means new edition of encyclopedia for loudspeaker and enclosure)”, Seibundo Shinkosha Publishing Co., 1999, p. 54. As can be seen from FIG. 4, diaphragm 1 using the DCPD resin according to the present embodiment exhibits the relationship closer to an ideal physical balance than the diaphragm using PP exhibits. For this reason, the loudspeaker using diaphragm 1 can achieve flat and stable frequency response characteristics, higher threshold frequency, and high-fidelity reproduction.

Note that specific modulus is elastic modulus per unit volume, and is determined by dividing a measured elastic modulus by density of the constituent material concerned. Densities of PP and the DCPD resin are approximately 1 g/cm³. Thus, the specific modulus of a material with an elastic modulus of 2 GPa (2 kg/ms²) is determined to be 2×10¹⁰ cm²/s². Realistically, because a filler is introduced when the diaphragm is produced, the elastic modulus becomes about 2 GPa when PP is used, while the elastic modulus becomes about 4 GPa when the DCPD resin is used.

Note that in cases where a loudspeaker having a diaphragm made of a thermoplastic material is installed in high-temperature environments, it will suffer from deformation over time, resulting in degradation in acoustic characteristics. In contrast, because the DCPD resin used in the present embodiment is a thermosetting resin, the loudspeaker using diaphragm 1 can maintain its stable shape and acoustic characteristics over long service time, even if the loudspeaker is installed in severe environments of, such as, the engine room or cabin of a vehicle.

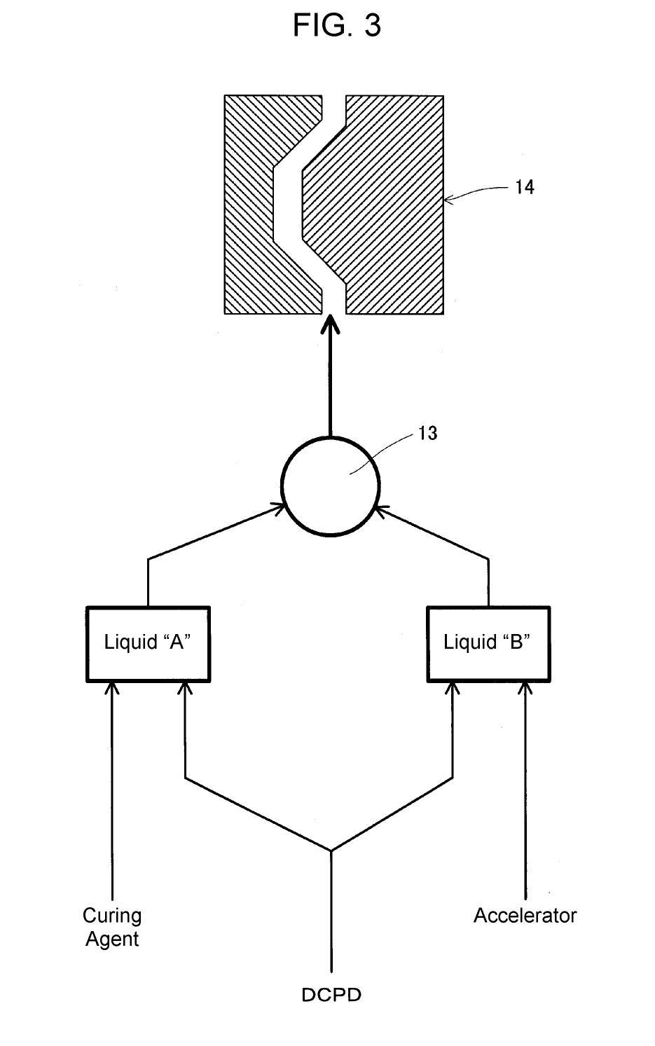

FIG. 3 is a view illustrating a configuration of a molding machine for forming diaphragm 1. Diaphragm 1 can be manufactured with the machine as follows: That is, liquid “A” is prepared by blending dicyclopentadiene (referred to as DCPD, hereinafter) with a curing agent, while liquid “B” is prepared by mixing and blending DCPD with an accelerator. Then, these two liquids are mixed via mixing valve 13 and then injected into a cavity of mold 14, thereby performing injection molding. The reaction injection molding (RIM), which includes mixing two liquids with a mixing valve and injecting the mixed liquid into a mold for molding, is a known forming method; therefore, description of it is omitted.

For example, tungsten hexachloride can be used as the curing agent, and triethylaluminum can be used as the accelerator. The mixing ratio of liquid “A” to liquid “B” via mixing valve 13 is 1:1, for example. Moreover, the mold temperature after the mixture of the two liquids has been injected is 90° C., for example. For example, hold pressure and hold time are 2.0 MPa and 2 (two) minutes, respectively. In cases where diaphragm 1 is manufactured under the conditions exemplified above, the thickness of diaphragm 1 having been taken out from the mold is 0.1 mm.

As described above, diaphragm 1 can be manufactured, via RIM, from both liquid “A” prepared by blending DCPD with a curing agent and liquid “B” prepared by mixing and blending DCPD with an accelerator. However, for manufacturing diaphragm 1 having a smaller thickness and a higher stiffness required, a filler is added to at least one of liquid “A” and liquid “B.” Specifically, the filler may be a carbon-fiber filler. In this case, it is possible to increase the elastic modulus up to 5.0 GPa, for example.

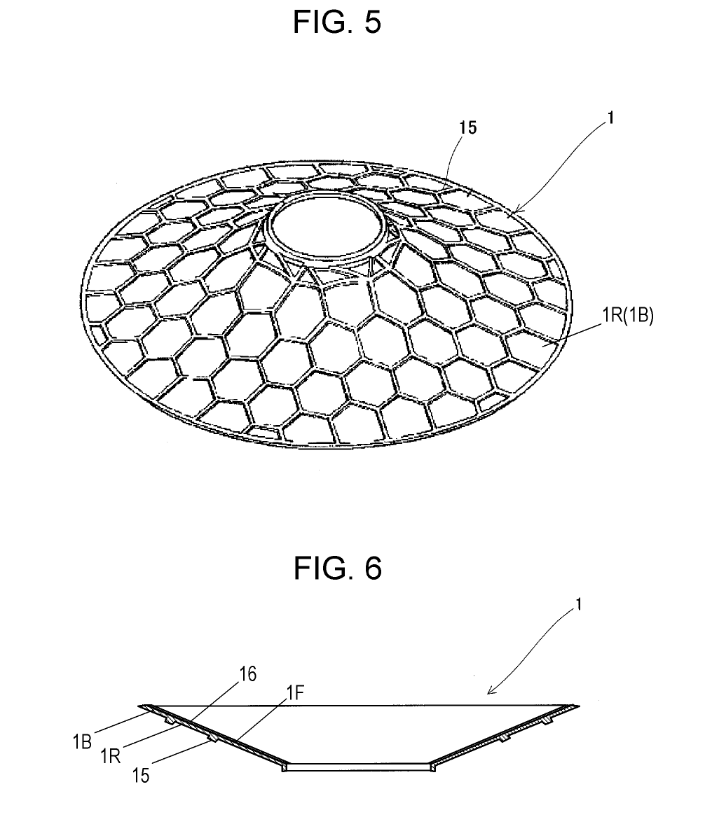

Moreover, another method of manufacturing diaphragm 1 having a smaller thickness and a higher stiffness required may be as follows: Mold 14 provided with grooves is used, thereby forming reinforcing ribs 15 on rear surface 1R of diaphragm 1 as shown in FIG. 5. When the loudspeaker is configured as shown in FIG. 1, rear surface 1R is a plane that faces magnetic circuit 5 while front surface 1F is an outer surface (a sound emitting surface) of the loudspeaker.

By injecting liquid “A” and liquid “B,” for injection molding, into mold 14 provided with the grooves, reinforcing ribs 15 made of the DCPD resin can be integrally formed on rear surface 1R of diaphragm 1. Note that, in FIG. 5, reinforcing ribs 15 are formed as a cluster of honeycomb geometries that is integrally formed, together with body part 1B, on rear surface 1R of body part 1B of diaphragm 1. The geometries are also disclosed in Japanese Patent Unexamined Publication No. 2007-221638, for example. However, the geometries of reinforcing ribs 15 are not limited to the geometries shown in FIG. 5.

The thermosetting liquid material, which is obtained by mixing liquid “A” and liquid “B,” is injected into mold 14 with the temperature of which is being appropriately controlled to. This allows the liquid material to reach into every corner of the grooves for forming reinforcing ribs 15. Reinforcing ribs 15 integrally formed on rear surface 1R of body part 1B allows diaphragm 1 to be improved in mechanical properties. This can allow the loudspeaker diaphragm to have a reduced weight relative to conventional ones, excellent acoustic characteristics, and a high suitability for mass production as well.

When reinforcing ribs 15 are integrally formed in this way on thin body part 1B, a flow of the resin into the grooves for forming reinforcing ribs 15 sometimes has an influence on body part 1B. That is, a pattern of the geometries of reinforcing ribs 15 may appear on front surface 1F of body part 1B. To be precise, unevenness in flowing of the black carbon-fiber filler may appear as well. In any case, front surface 1F is sometimes slightly recessed in a pattern of reinforcing ribs 15. In this case, coating film 16 may be formed on front surface 1F of body part 1B, as shown in FIG. 6.

In cases where the diaphragm is formed with PP as a resin material, it is difficult to coat it with a paint, resulting in a low degree of flexibility in decorative coating. In contrast, the DCPD resin has double bonds which can easily bond with a coating, resulting in a high degree of flexibility in decorative coating. Coating film 16 may be formed with an acrylic paint which has high adhesion properties to DCPD resins, thereby achieving a targeted texture.

Note that, even in cases where reinforcing ribs 15 are not formed, coating film 16 may be formed on front surface 1F of body part 1B, from a standpoint of decorative coating.

As described above, the present disclosure contributes to the improvement in performances of loudspeakers that are installed in severe environments of the engine rooms, cabins of vehicles and the like.

What is claimed is:

1. A loudspeaker diaphragm, containing a thermosetting resin as a principal component, the thermosetting resin including dicyclopentadiene serving as a framework structure.

2. The loudspeaker diaphragm according to claim 1, further containing a carbon-fiber filler contained in the thermosetting resin.

3. The loudspeaker diaphragm according to claim 1, having a conical shape.

4. The loudspeaker diaphragm according to claim 1, comprising:
a body part having a front surface and a rear surface; and
a reinforcing rib integrally formed on the rear surface of the body part.

5. The loudspeaker diaphragm according to claim 4, wherein the reinforcing rib configures a honeycomb geometry.

6. The loudspeaker diaphragm according to claim 1, comprising:
a body part having a front surface and a rear surface; and
a coating film disposed on the front surface of the body part.

7. A loudspeaker comprising:
a loudspeaker diaphragm according to claim 1;
an edge bonded to an outer periphery of the loudspeaker diaphragm;
a magnetic circuit including a yoke, a magnet, and a plate, and being provided with a magnetic gap;
a frame attached to the magnetic circuit, and supporting the outer periphery of the loudspeaker diaphragm via the edge;
a voice coil including:
a first end attached to the diaphragm; and
a second end on which a coil is wound, the wound coil being positioned in the magnetic gap; and
a damper joined to both the frame and the voice coil.
